(19) United States
(12) Patent Application Publication
(10) Pub. No.: US 2026/0044479 A1
(43) Pub. Date: Feb. 12, 2026

(54) STREAM-BASED DEDUPLICATION OF UNIFORM OBJECT LOCATOR PATH COMPONENTS

(71) Applicant: Jon Lee Boynton, North Fort Myers, FL (US)

(72) Inventor: Jon Lee Boynton, North Fort Myers, FL (US)

(21) Appl. No.: 19/292,862

(22) Filed: Aug. 6, 2025

Related U.S. Application Data
(60) Provisional application No. 63/680,092, filed on Aug. 7, 2024.

(51) Int. Cl. G06F 16/215

(52) U.S. Cl. CPC G06F 16/215

(57) ABSTRACT

A computer-implemented method for deduplicating Uniform Object Locator (UOL) path components in data streams by splitting UOL paths into context and name components, assigning unique tokens via a dictionary, prefixing component-token pairs and composite tokens with markers, and writing them to the stream. Receivers reconstruct UOLs by parsing markers, retrieving components from a dictionary using tokens, and combining them. The method reduces bandwidth and enhances performance by removing redundant path components from data streams.

### RELATED APPLICATIONS

This application claims priority under 35 U.S.C § 119 (e) to U.S. Provisional Patent Application Ser. No. 63/680,092, filed Aug. 7, 2024.

### TECHNICAL FIELD

The invention relates to data deduplication and reconstruction in computer systems, specifically for optimizing Uniform Object Locator (UOL) paths in streamed data.

### BACKGROUND

Streaming data with UOLs in distributed networks often faces challenges in bandwidth efficiency and processing speed, particularly in high throughput, resource-constrained environments like Internet of Things (IoT) systems. This invention provides token-based deduplication and marker-prefixed reconstruction to efficiently reuse UOL path components while preserving semantic integrity.

Uniform Object Locators (UOLs), a proposed subset of Uniform Resource Identifiers (URIs) conforming to URI Generic Syntax, comprise two hierarchical components separated by ‘@’: a context (elements separated by ‘/’) representing an abstract path or declaration, and a name (elements separated by ‘.’) representing its logical identity. These reusable components make UOLs ideal for stream-based deduplication. The invention supports UOL and other URI variants with similar context and name structures, collectively referred to herein as UOL.

Existing data stream processing methods, such as general-purpose compression (e.g., gzip, LZ77), encode repeated patterns but fail to leverage UOL-specific redundancies. Tokenization in network protocols assigns codes to recurring elements, yet may disrupt the semantic relationship between UOL context and name components, hindering accurate reconstruction.

Prior art includes hash-based deduplication, which hashes data segments into fixed-length codes to eliminate duplicates. This approach processes entire data blocks without splitting UOLs for targeted deduplication in streams. Dictionary-based compression maps frequent strings to shorter codes but lacks marker-based reconstruction for dynamic UOL streaming. Similarly, XPath path compression optimizes XML query performance by indexing paths but does not address UOL deduplication in dynamic streams.

Existing methods, while effective for broad data processing, introduce computational and network overhead inefficient for UOL-specific deduplication. Thus, there remains a need for streamlined methods to deduplicate and reconstruct UOL path components in real-time streams.

### BRIEF DESCRIPTION OF DRAWINGS

For a more complete understanding of the subject matter and the advantages thereof, reference is now made to the following descriptions taken in conjunction with the accompanying drawings, in which:

FIG. 1: is a typical example of a UOL path

FIG. 2: is a table of various related UOLs

FIG. 3: illustrates the structure of an output stream after deduplication

FIG. 4: shows a block diagram illustrating a method for deduplicating UOL path components in a data stream.

FIG. 5: shows a block diagram illustrating a method for reconstructing UOLs from deduplicated UOL path components in a data stream.

FIG. 6: is a system architecture for deduplicating UOL path components and reconstructing UOLs in a computer network.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code.

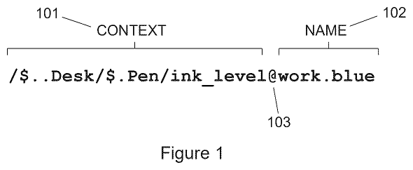

FIG. 1 Illustrates a typical example UOL identifier. For clarity as to the benefits offered by the invention, the example UOL will now be described in detail. The UOL consists of a string of characters having, at most, one commercial ‘@’ delimiter (103). The substring of characters preceding the ‘@’ are presently referred to as the context component or context (101). The substring of characters following the ‘@’ are presently referred to as the name component or name (102). Together, the context, ‘@’, and name comprise a complete UOL path component.

While described with respect to UOLs, it will be apparent to one skilled in the art, the invention supports other URI variations with similar context and name components, all referred to herein as UOL or UOLs. Examples of UOLs are illustrative and not limiting; the invention applies to any URI, official or unofficial, with a path component splitable into context and name components, in either order.

In the example UOL, the context (101) describes an abstract path for reading the ink level in a pen within a desk. In theory, such a path could describe the ink level in any pen, within any desk. The name (102) provides an identity to the desk and pen such that the desk is a “work” desk and the pen is a “blue” pen. Together, the context and name form a composite key that uniquely identifies “ink_level.”

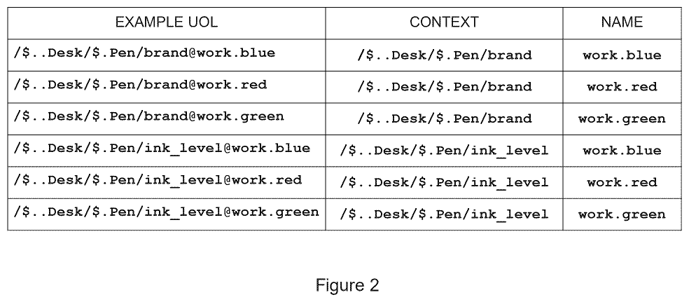

FIG. 2 Expands on the example in FIG. 1 by providing a table showing a range of related UOLs. The CONTEXT column of the table shows the context component for each EXAMPLE UOL while the NAME column shows the name component for each EXAMPLE UOL. Although each example UOL is unique, at least some context components and name components are duplicated.

One or more embodiments of the present invention relate to a computer implemented method for deduplicating context and name components in a data stream containing UOLs. As an example, the method may be used by a peer to send a stream of UOL requests over a network to another peer having a database.

The method may utilize a dictionary of unique components to map tokens, whereby each component lookup returns a token. A missing component will result in generation of a component-token pair consisting of a component and unique token. The entry is added to the dictionary, and then copied to the stream.

Component-token pairs are copied to a stream as a three-part sequence. The first part is a fixed length “component marker” that indicates the start of a component-token pair. The second part is a string encoded representation of a UOL path component. For example, a context or name encoded by the utf-8 specification. The third part is the unique token.

The overall length of a component-token sequence is variable. The length can be discovered by adding the marker length to a length indicated by reading, at least, some bytes from the component string and the token.

The method sends a stream of UOLs processed in sequence. Each UOL is split into a context component and name component. The dictionary is used to retrieve a mapped token for each component. A “composite token,” combining a context mapped token and name mapped token, is added to the stream as part of a UOL entry.

A UOL entry is a multi-part sequence having, at least, two parts. The first part is a fixed length “UOL marker” that indicates the start of a UOL entry. At least, one additional part is a composite token. The value expressed by a UOL marker depends on the number of parts in the UOL entry and their respective states or configurations. At minimum, the marker will indicate the overall length of a UOL entry, and the composite token configuration.

In some embodiments of the invention, the component marker and the UOL marker may utilize bit packing techniques to indicate state or configuration with respect to an entry. Techniques may include, but are not limited to, bitwise operators and bit masking.

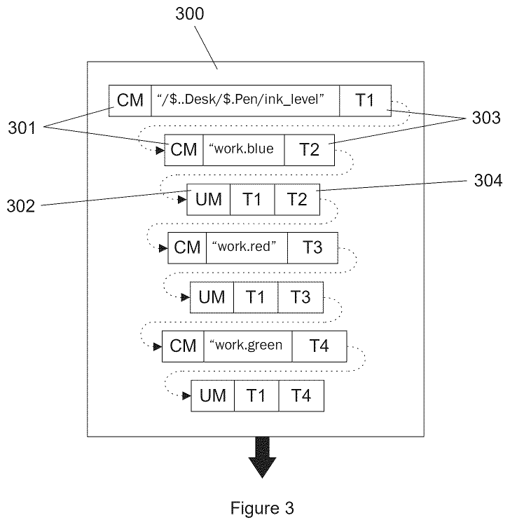

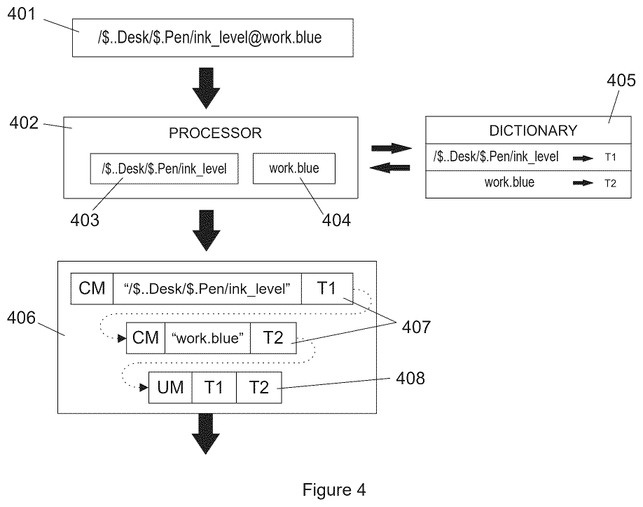

To clarify embodiments above, FIGS. 3 and 4, relating to deduplication of UOL context and name components will now be described in detail:

FIG. 3: This figure illustrates the structure of an output stream after deduplication (300). The stream deduplicates path components from a stream of UOLs indicated in FIG. 2. In particular, those UOL referencing “ink_level” for blue, red, and green pens within a work desk. The deduplicated stream includes unique component token pairs (303) with component markers (301) and composite tokens (304) with UOL markers (302), using tokens to reduce stream size. Stream data is written starting from the top-left, flowing left to right across rows, and progressing downward.

FIG. 4: This figure shows a block diagram illustrating a method for deduplicating UOL path components in a data stream. The diagram depicts a stream containing UOL identifiers (401), each composed of a context component and a name component. A processor (402) receives the stream of UOLs, where each is split into its components (404, 405), and unique tokens are assigned from a dictionary (403).

Component-token pairs are prefixed with a component marker (407), and composite tokens, combining context and name tokens, are prefixed with a UOL marker (408). These are written to the output stream (406), where data is written starting from the top-left, flowing left to right across rows, and progressing downward, reducing redundancy. An example dictionary (403) shows token assignments (e.g., context1→T1, name1→T2), highlighting efficiency in handling repetitive components.

Other embodiments of the present invention relate to a computer implemented method for reconstructing UOLs from deduplicated UOL path components in a data stream. As an example, the method may be used by a peer having a database, to receive a stream of UOL requests over a network from another peer.

This method may utilize a dictionary of tokens to map unique components, whereby each token lookup returns a component. A process scans the incoming stream for component markers and UOL markers.

When a component marker is read from the stream, it indicates the start of a component-token pair. Following the marker, the component value is read from the stream. Then, a token is read from the stream. The component value is inserted into the dictionary using the token as a key.

When a UOL marker is read from the stream, it indicates the start of a UOL entry. Following the marker, the entry parts are read from the stream. Each part conforms to a configuration indicated by the marker. At least one part is a composite token. The configuration of the composite token is used to decompose it into a context token and a name token. The dictionary is used to retrieve a component for each token. The context component and name component are combined to make a UOL. The resulting UOL is added to the output of the process.

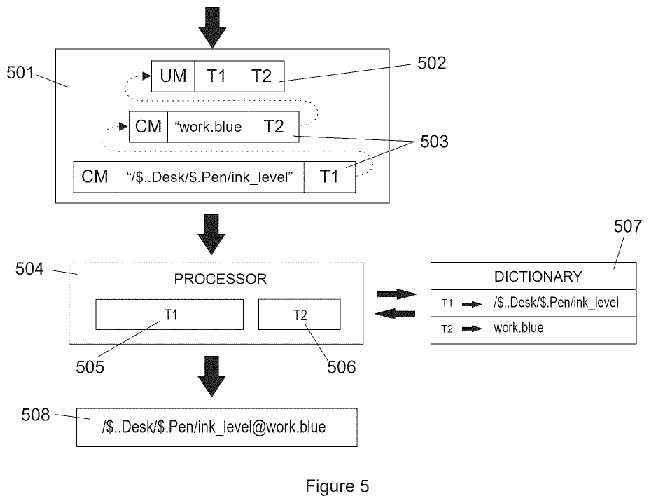

The method above is further described by FIG. 5. The figure depicts a data stream (501) with component-token pairs (503) and composite tokens (502). The data stream is illustrated as input stream in a reversed row-major order, where data is read starting from the bottom-left, flowing left to right across rows, and progressing upward. A processor (504) parses the stream to identify component markers and UOL markers. A dictionary (507) maps tokens to context components and name components. Composite tokens (502) are split into context and name tokens (505, 506), and the dictionary (507) retrieves corresponding components to reconstruct the original UOL stream (508), ensuring accurate data recovery.

In some embodiments, the invention may be implemented as a system comprising one or more computing devices, each including a processor and a memory, configured to perform the methods described herein. The system includes a dictionary storage, which may be implemented as a database, memory module, or other data structure stored on a computer-readable medium, to maintain mappings between components and tokens or tokens and components. The processor may be a general-purpose processor, a microcontroller, or a specialized processing unit configured to execute instructions for receiving and processing data streams, splitting UOLs into path components, generating and parsing tokens, and prefixing component-token pairs and composite tokens with markers. The system may operate in a networked environment, where the receiving peer is another computing device or software module communicating over a wired or wireless network. The dictionary storage may be local to the processor or distributed across multiple devices, accessible via standard communication protocols. The system is designed to handle continuous or batched data streams, supporting real-time or buffered processing as needed to deduplicate UOL path components and reconstruct UOLs from deduplicated components efficiently.

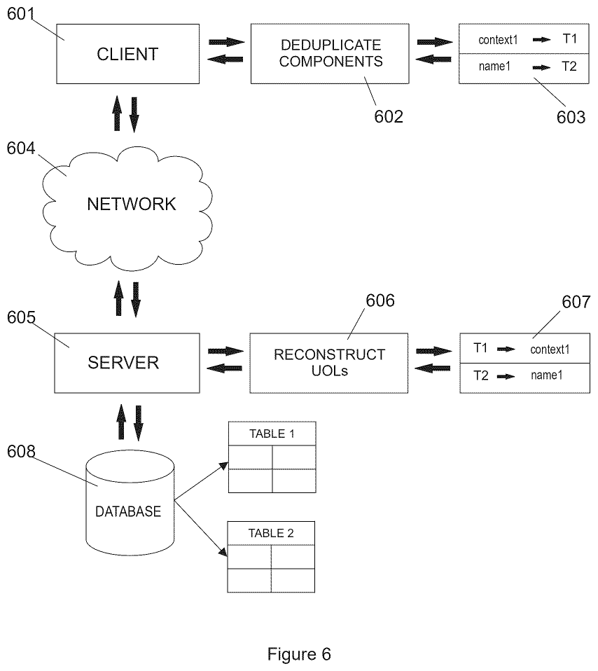

FIG. 6 shows a system architecture for deduplicating UOL path components and reconstructing UOLs in a computer network. A client (601), such as an IoT device, sends a stream of UOLs to a processor (602), which deduplicates UOL path components, via a local dictionary with components mapped to tokens (603). The client receives a stream of component-token pairs and composite tokens from the processor and sends it over the network (604) to a host server (605). The server sends the deduplicated input stream to a processor (606), which reconstructs UOLs, via a dictionary with tokens mapped to components (607). The server receives a stream of reconstructed UOLs and uses it to retrieve data from tables in a database (608). The process is then reversed to send a data stream back to the client. Arrows depict data flow, illustrating efficient interaction.

The approach of this disclosure does not require synchronization of dictionaries between peers. In at least one embodiment of the invention, the dictionary on a sending process may have additional component-token references, and/or the dictionary on the receiving process may have additional token-component references, provided that each dictionary correctly maps the same component token pairs written to the data stream.

In other embodiments, dictionaries are transient and only exist temporarily on a computer implemented method. The dictionary is initialized at the start of a stream process and cleared of all entries at the end of the stream process. Only component entries added to the stream by a sending process are available to a receiving process. Thus, insuring against token collisions

In embodiments described above, there is no limit on further processing of the UOLs sent or received. Other embodiments may include, but are not limited to, processes with creating, retrieving, updating, deleting, and storing data with UOL identifiers.

While the above embodiments describe processes with one dictionary for mapping context and name tokens, it should be understood that such processes are exemplary, as alternate embodiments may perform processes with more than one dictionary, including, but not limited to, a dictionary for mapping context tokens and a dictionary for mapping name tokens. References in the specification to a given embodiment Indicate that the embodiment described may include a particular feature, structure, or characteristic, but every embodiment may not necessarily include the particular feature, structure, or characteristic.

The foregoing description of embodiments is not intended to be exhaustive or to limit the invention to the precise forms disclosed; rather, various changes, substitutions, and alterations can be made without departing from the invention's scope.

The invention includes all equivalents to the structures and methods described herein, as would be apparent to one skilled in the art. Although specific embodiments have been described herein, various modifications and variations may be made without departing from the spirit and scope of the invention as defined by the appended claims.

What is claimed is as follows:

1. A computer-implemented method for deduplicating UOL path components in a data stream, comprising:
receiving a data stream with UOLs, each having a context component and a name component; splitting each UOL into its context and name components; obtaining a unique token for each component from a dictionary, wherein new components are assigned new tokens and duplicate components reuse existing tokens; for each unique component-token pair, prefixing it with a component marker for recognition by a receiving peer and writing it to the data stream; generating a composite token combining the context token and name token; prefixing the composite token with a UOL marker for recognition by a receiving peer; and writing the prefixed composite token to the data stream to represent the UOL.

2. The method of claim 1, wherein the component marker and UOL marker each include a static identifier indicating whether the marker corresponds to a component-token pair or a composite token.

3. The method of claim 1, wherein the component marker and UOL marker each include a bit-packed portion indicating a state or configuration of the component-token pair or composite token.

4. The method of claim 1, wherein generating the composite token includes combining the context token and name token into a sequence in a predefined order.

5. The method of claim 1, wherein the tokens generated for each component are of a fixed length.

6. The method of claim 1, wherein the component marker and UOL marker are of a fixed length.

7. A computer-implemented method for reconstructing UOLs from deduplicated UOL path components in a data stream, comprising:
receiving a data stream with component-token pairs and composite tokens, each component-token pair prefixed with a component marker and each composite token prefixed with a UOL marker; maintaining a dictionary that maps tokens as keys to components as values; parsing each component marker to identify a component-token pair and storing the token as a key and the component as a value in the dictionary; parsing each UOL marker to identify a composite token;
retrieving a context token and a name token from the composite token; accessing the dictionary to obtain the context component and name component using the context token and name token as keys; and reconstructing a UOL by combining the retrieved context component and name component.

8. The method of claim 7, wherein the component marker and UOL marker each include a static identifier indicating whether the marker corresponds to a component-token pair or a composite token.

9. The method of claim 7, wherein the component marker and UOL marker each include a bit-packed portion indicating a state or configuration of the component-token pair or composite token.

10. The method of claim 7, wherein the tokens in the component-token pairs and composite token are of a fixed length.

11. The method of claim 7, wherein retrieving the context token and name token from the composite token includes parsing the composite token to extract a combined sequence of the context token and name token.

12. The method of claim 7, wherein the component marker and UOL marker are of a fixed length.

13. A system for deduplicating UOL path components and reconstructing UOLs from deduplicated UOL path components in a data stream, comprising:
a processor and a dictionary storage on a sending peer, the processor configured to:
receive a data stream with UOLs, each having a context component and a name component; split each UOL into its context and name components; obtain a unique token for each component from the dictionary storage, wherein new components are assigned new tokens and duplicate components reuse existing tokens; for each unique component-token pair, prefix it with a component marker for recognition by a receiving peer and write it to the data stream; generate a composite token combining the context token and name token; prefix the composite token with an UOL marker for recognition by a receiving peer; write the prefixed composite token to the data stream;
a processor and a dictionary storage on a receiving peer, the processor configured to:
receive the data stream at the receiving peer; maintain a dictionary that maps tokens as keys to components as values in the dictionary storage;
parse each component marker to identify a component-token pair and store the token as a key and the component as a value in the dictionary;
parse each UOL marker to identify a composite token; retrieve a context token and a name token from the composite token; access the dictionary to obtain the context component and name component using the context token and name token as keys; and reconstruct a UOL by combining the retrieved context component and name component.

14. The system of claim 13, wherein the component marker and UOL marker each include a static identifier indicating whether the marker corresponds to a component-token pair or a composite token.

15. The system of claim 13, wherein the component marker and UOL marker each include a bit-packed portion indicating a state or configuration of the component-token pair or composite token.

16. The system of claim 13, wherein generating the composite token includes combining the context token and name token into a sequence in a predefined order.

17. The system of claim 13, wherein the tokens generated for each component are of a fixed length.

18. The system of claim 13, wherein the component marker and UOL marker are of a fixed length.
